(19) United States
(12) Patent Application Publication
(10) Pub. No.: US 2017/0092303 A1
(43) Pub. Date: Mar. 30, 2017

(54) SCISSOR TYPE MAGNETIC SENSOR HAVING AN IN-STACK LONGITUDINAL STABILIZATION STRUCTURE

(71) Applicant: HGST Netherlands B.V., Amsterdam (NL)

(72) Inventors: Hongquan Jiang, San Jose, CA (US); Quang Le, San Jose, CA (US); Xiaoyong Liu, San Jose, CA (US); Masaya Nishioka, San Jose, CA (US); Lei Wang, Fremont, CA (US)

(21) Appl. No.: 14/871,747

(22) Filed: Sep. 30, 2015

(51) Int. Cl. G11B 5/31

(52) U.S. Cl. CPC G11B 5/315

(57) ABSTRACT

A scissor type magnetic sensor having an in stack magnetic bias structure for biasing first and second magnetic free layers. The in stack bias structure can include a magnetic tab that is exchange coupled with a magnetic shield so as to pin its magnetization in a desired direction parallel with the media facing surface. The magnetic tab can be separated from the free magnetic layer by a non-magnetic de-coupling layer that magnetically de-couples the magnetic tab from the magnetic free layer. A magnetostatic field from the edges of the magnetic tab can provide magnetic biasing for the magnetic free layer. Alternatively, the magnetic tab can be separated from the magnetic free layer by a very thin non-magnetic dusting layer that provides a weak magnetic exchange coupling (either parallel or anti-parallel) between the magnetic tab and the magnetic free layer.

### FIELD OF THE INVENTION

The present invention relates to magnetic data recording and more particularly to a scissor type magnetic sensor with an in stack longitudinal stabilization structure for improved magnetic free layer biasing.

### BACKGROUND

At the heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic information to and reading magnetic information from the rotating disk. The read and write heads are connected to processing circuitry that operates according to a computer program to implement the writing and reading functions.

The write head includes at least one coil, a write pole and one or more return poles. When current flows through the coil, a resulting magnetic field causes a magnetic flux to flow through the coil, which results in a magnetic write field emitting from the tip of the write pole. This magnetic field is sufficiently strong that it locally magnetizes a portion of the adjacent magnetic media, thereby recording a bit of data. The write field then, travels through a magnetically soft under-layer of the magnetic medium to return to the return pole of the write head.

A magneto-resistive sensor such as a Giant Magnetoresistive (GMR) sensor or a Tunnel Junction Magnetoresistive (TMR) sensor can be employed to read a magnetic signal from the magnetic media. The magnetoresistive sensor has an electrical resistance that changes in response to an external magnetic field. This change in electrical resistance can be detected by processing circuitry in order to read magnetic data from the magnetic media.

As demands for data density have increased, researchers have been seeking ways to decrease magnetic bit spacing in order to increase linear data density. One way to achieve this is through the use of scissor type magnetic sensors. Unlike GMR or TMR sensors, scissor type sensors have no pinned layer, but instead have two magnetic free layers that have magnetizations that move in a scissoring fashion relative to one another. The use of such a scissor sensor eliminates the need for a magnetic pinning structure which would otherwise consume a large amount of read gap spacing. However, in order to be practical, the use of such a scissor sensor would require an effective magnetic biasing structure to maintain proper alignment of the magnetizations of the free layers. Therefore, there remains a need for a biasing structure for effectively maintaining proper orientation of the magnetizations of magnetic free layers in a magnetic scissor sensor.

### SUMMARY OF THE INVENTION

The present invention provides a magnetic sensor that includes first and second magnetic free layers that are anti-parallel coupled across a non-magnetic layer sandwiched there-between and having magnetizations that move in a scissoring fashion relative to one another. The sensor also includes an in-stack magnetic bias structure for providing a magnetic bias for at least one of the first and second magnetic free layers, in addition to either a hard or soft magnetic biasing layer at the back of sensor stack in stripe height direction. The in-stack magnetic bias structure can include a magnetic tab layer that is separated from the one of the first and second magnetic free layers by a non-magnetic decoupling layer, such that a de-magnetization field from the magnetic tab provides a magnetic bias field for biasing the magnetization of the magnetic free layer. Alternatively, the in-stack magnetic bias structure can include a magnetic layer that is separated from the magnetic free layer by a non-magnetic layer that has a thickness that provides a weak exchange coupling between the magnetic layer and the magnetic free layer. Further alternatively, the magnetic layer can be separated from the magnetic free layer by a non-magnetic layer such as Ru that is of such a thickness as to weakly, anti-parallel, exchange couple the magnetic layer with the magnetic free layer.

The present invention advantageously provides an effective well controlled magnetic biasing for ensuring magnetic stability of the magnetic free layers in the magnetic sensor and suppresses excessive signal noise of scissor sensor near the parallel magnetization state.

These and other features and advantages of the invention will be apparent upon reading of the following detailed description of the embodiments taken in conjunction with the figures in which like reference numeral indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an exploded, schematic illustration of magnetic orientation of magnetic free layers in a scissor type magnetic sensor;

FIG. 3 is a view of a magnetic sensor according to an embodiment as viewed from the media facing surface plane;

FIG. 4 is a view of a magnetic sensor according to another embodiment as viewed from the media facing surface plane; and

FIG. 5 is a view of a magnetic sensor according to still another embodiment as viewed from the media facing surface plane.

### DETAILED DESCRIPTION

The following description is of the best embodiments presently contemplated for carrying out this invention. This description is made for the purpose of illustrating the general principles of this invention and is not meant to limit the inventive concepts claimed herein.

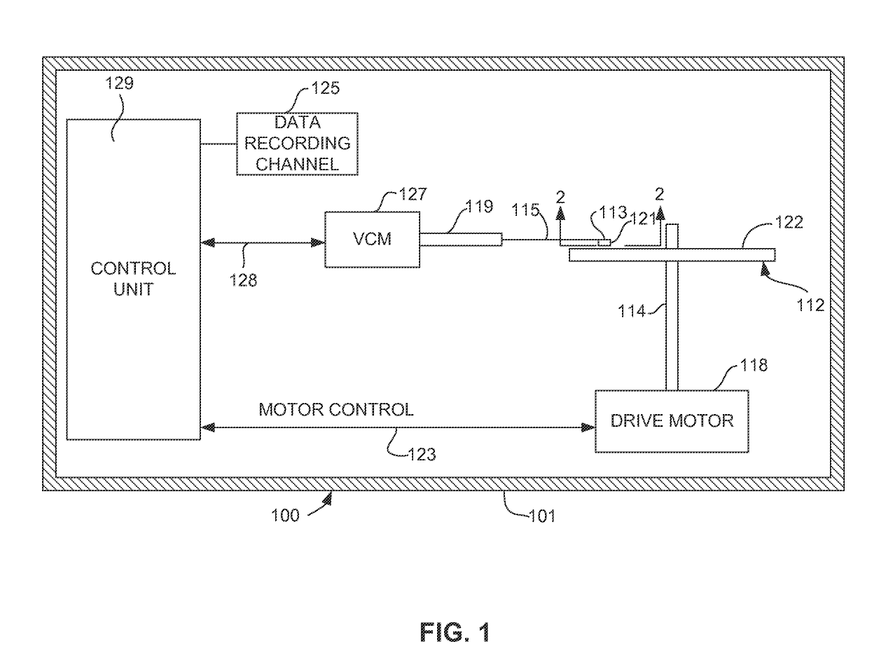

Referring now to FIG. 1, there is shown a disk drive 100. The disk drive 100 includes a housing 101. At least one rotatable magnetic disk 112 is supported on a spindle 114 and rotated by a disk drive motor 118. The magnetic recording on each disk may be in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases the slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by the controller 129.

During operation of the disk storage system, the rotation of the magnetic disk 112 generates an air bearing between the slider 113 and the disk surface 122, which exerts an upward force or lift on the slider. The air bearing thus counter-balances the slight spring force of the suspension 115 and supports the slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, and a microprocessor. The control unit 129 generates control signals to control various system operations such as drive motor control signals on line 123 and head position and seek control signals on line 128. The control signals on line 128 provide the desired current profiles to optimally move and position the slider 113 to the desired data track on the media 112. Write and read signals are communicated to and from write and read heads 121 by way of recording channel 125.

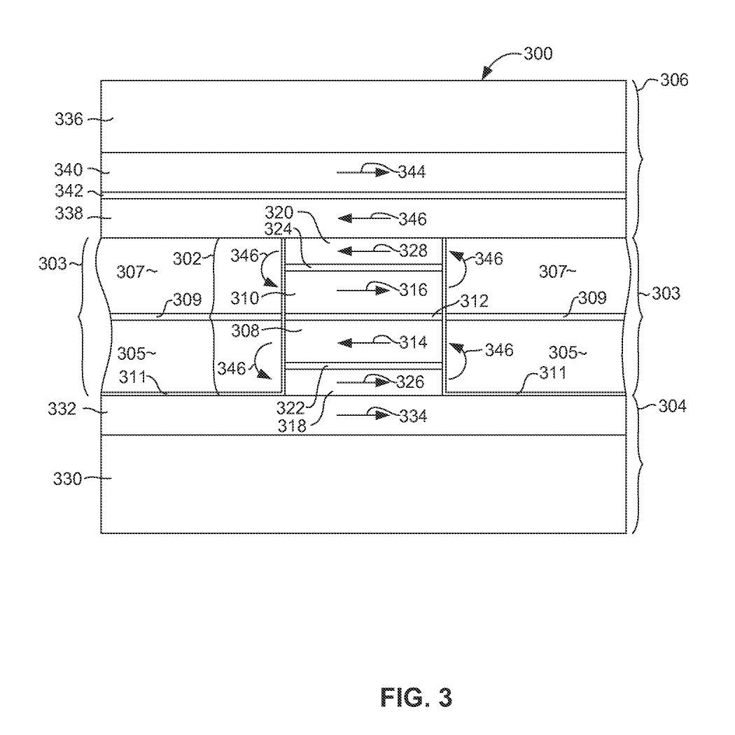

FIG. 3, is a view of a magnetic sensor 300 according to one possible embodiment. The sensor includes a sensor stack 302 that is sandwiched between a leading magnetic shield 304 and a trailing magnetic shield 306. The sensor stack includes first and second magnetic free layers 308, 310 with a non-magnetic spacer or barrier layer 312 sandwiched between the first and second free layers 308, 310. The non-magnetic spacer or barrier layer 312 has an electrical resistance that changes depending on the relative orientation of magnetizations 314, 316 of the free layers 308, 310. The space at either side of the sensor stack 302 in the width direction can include anti-parallel coupled soft magnetic side shields 303 that each include a lower soft magnetic layer 305, an upper soft magnetic layer 307 and a non-magnetic anti-parallel coupling layer 309 sandwiched between the upper and lower soft magnetic layers 305, 307. Each of soft magnetic side shield structures 303 can be separated from the sensor stack 302 and from the bottom shield 304 by an electrically insulating layer 311.

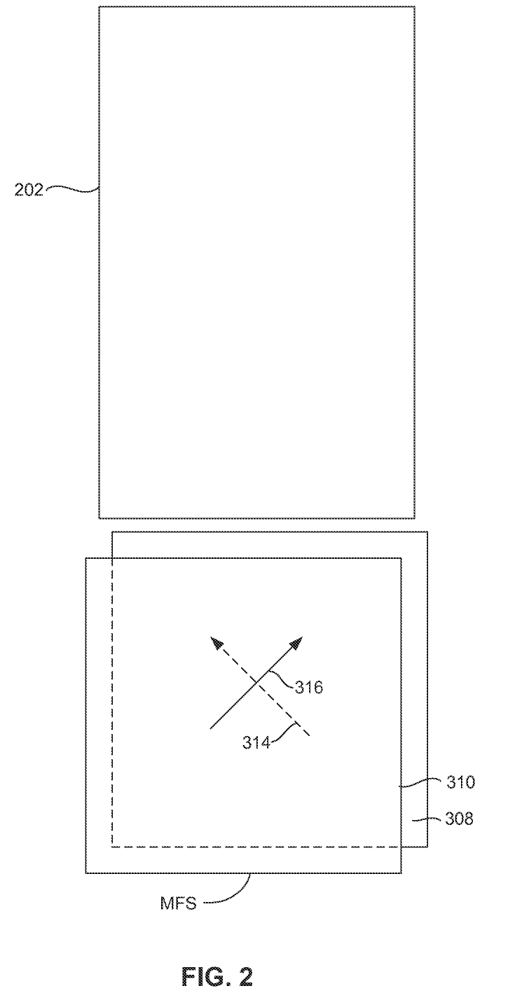

The orientation of the magnetizations 314, 316 of the free layers 308, 310 can be better understood with reference to FIG. 2 which shows an exploded, schematic illustration of the free layers 308, 310, and magnetizations 314, 316. FIG. 2 shows the free layer 310 and the free layer 308 beneath the free layer 310. The magnetizations 314, 316 of the free layers 308, 310 are generally orthogonal to one another as shown during quiescent state (i.e in the absence of a magnetic field from the magnetic media). The magnetic free layers 308, 310 are anti-parallel coupled with one another across the non-magnetic layer 312 (FIG. 3) through magneto-static interaction. This anti-parallel coupling, along with a magnetic anisotropy, would tend to cause the magnetizations 314, 316 to be anti-parallel with one another in a direction parallel with the media facing surface MFS. However, by providing a transverse bias field using a magnetic biasing structure 202 at back of the sensor stack, the magnetizations can be moved such that they are generally orthogonal to one another in a quiescent state as shown. In the presence of a magnetic field, such as from a magnetic media, the magnetizations move in a scissoring fashion. This movement causes an electrical resistance change that can be used to detect a magnetic field. However, such scissor operation can inherently introduce excessive noise pick up when operated closer to parallel state (or when the angle between the magnetizations of the free layers 308 and 310 is closer to zero). This is because of flipping of magnetizations of the two free layers, and this excessive noise results in a reduction of signal to noise ratio and severe head instability.

Therefore, as described above, in order to maintain the desired magnetization directions and at the same time prevent introduction of excess noise closer to the parallel state as shown in FIG. 2, a longitudinal magnetic bias structure is provided. FIG. 3 illustrates a magnetic sensor 300 having an in-stack bias structure for providing a longitudinal magnetic bias for maintaining free layer magnetization in a desired orientation such as described above. As shown in FIG. 3, the sensor 300 includes magnetic tabs 318, 320. The magnetic tab 318 is exchange coupled with the bottom shield 304 and the magnetic tab 320 is exchange coupled with the upper shield 306. In addition, the magnetic tab 318 is separated from the adjacent free layer 308 by a non-magnetic de-coupling layer 322 and the magnetic tab 320 is separated from the adjacent free layer 310 by a non-magnetic de-coupling layer 324. The non-magnetic de-coupling layers 322, 324 are sufficiently thick to magnetically de-couple the magnetic tabs 318, 320 from each adjacent free layer 308, 310. For example, the non-magnetic separation layers 322, 324 can each have a thickness of about 20A, and can be constructed of Cr, NiCr, Ta, Ru Pd, Ir et all or combination of them. The magnetic tab 318 has a magnetization direction 326 that is oriented in a first direction that is parallel with the media facing surface as shown in FIG. 3. The magnetic tab 320 has a magnetization 328 that is oriented in a second direction that is parallel with the media facing surface and opposite to the first direction of the magnetization 326.

These magnetizations 326, 328 are pinned by exchange coupling with the magnetic shields 304, 306. The shields 304, 306 can have a structure that pins the magnetization of at least one layer of the shield structure so as to pin the magnetizations 326, 328 of the magnetic tabs 318, 320. For example, the shield structure 304 can have a layer of antiferromagnetic material (AFM layer 330) and a magnetic layer 332 that is exchange coupled with the AFM layer 330. The AFM layer can be a material such as IrMn, and the exchange coupling between the AFM layer 330 and the magnetic layer 332 pins the magnetization of the magnetic layer 332 in a direction that is parallel with the media facing surface as indicated by arrow 334. The exchange coupling between the magnetic layer 332 and the magnetic tab 318 pins the magnetization 326 of the tab 318 in the same direction as the magnetization 334 of the magnetic layer 332.

In a similar manner, the upper magnetic shield 306 includes a layer of antiferromagnetic material (AFM layer) such as IrMn 336. The upper shield 306 may also include an anti-parallel coupled magnetic structure including first and second magnetic layers 338, 340 that are anti-parallel coupled across an antiparallel coupling layer 342 such as Ru located between the magnetic layers 338, 340. The AFM layer 336 is exchange coupled with one of the magnetic layers 340, which pins the magnetization of that layer in a direction parallel with the media facing surface as indicated by arrow 344. The antiparallel coupling of the magnetic layers 338, 340 pins the magnetization of the layer 338 in a direction opposite to that of the layer 340 as indicated by arrow 346.

This structure of the shields 304, 306 allows the layer 338 to have a pinned magnetization to pin the adjacent magnetic tab 320 and allows the layer 332 to have a pinned magnetization to pin the adjacent magnetic tab 318. It should also be pointed out that the magnetizations of the tabs 318 and 320 are in opposite directions in order to cause the desired orientation of the magnetizations 314, 316 of the free magnetic layers 308, 310. As those skilled in the art will appreciate, the pinning of the magnetic layers 332, 338, 340 of the shields 304, 306 is performed in an annealing process that involves heating the sensor and applying a magnetic field. This results in an exchange coupling between layer 330/332 and layers 340, 336 that causes the magnetizations 344, 334 to be in the same direction. Therefore, in order for the shields 304, 306 to pin the magnetizations of the magnetic tabs 318, 320 in opposite directions, it is desirable that one shield have an odd number of magnetic layers (e.g. one layer 332) and that the other shield have an even number of magnetic layers (e.g. two layers 338, 340). However, although the shields 304, 306 are shown as having a single layer and two layers respectively, this is by way of example and some other numbers of magnetic layers could be used as well.

With continued reference to FIG. 3, the magnetic tabs 318, 320 provide longitudinal magnetic biasing of the free magnetic layers 308, 310 through de-magnetization fields indicated by arrows 346. In order to facilitate such a de-magnetization field it is desirable that the magnetic tabs 318, 320 have sides that are generally aligned with the sides of the free layers 308, 310, whereas the magnetic layers 332, 338 of the shields 304, 306 extend beyond the width of the free layers 308, 310. This facilitates the de-magnetization field at the sides of the tabs 318, 320 and free layers 308, 310, and provides a stronger de-magnetization field than would be possible if the free layers 308, 310 were anti-parallel coupled directly with the shields 304, 306.

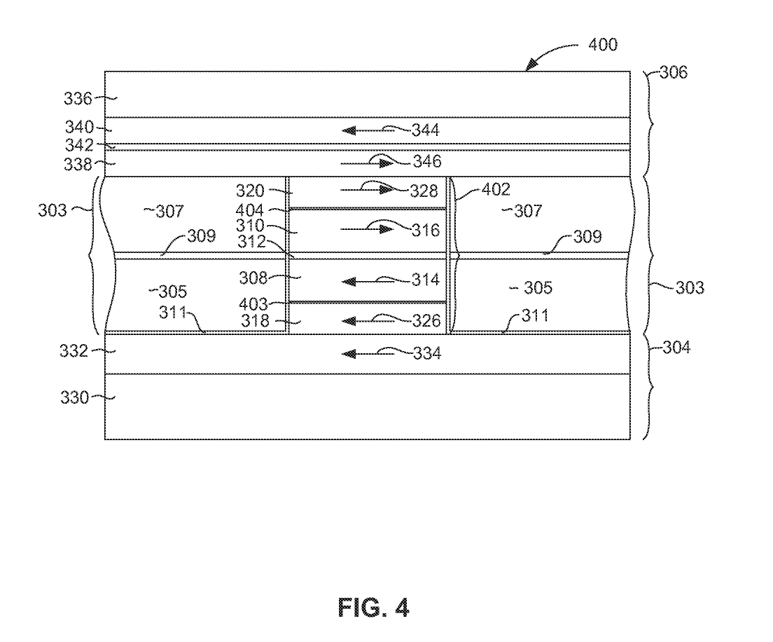

With reference now to FIG. 4, a magnetic read head 400 is described that has a longitudinal biasing structure according to another embodiment. This read head has a sensor stack 402 that is located between magnetic shield structures 304, 306 that may be similar to the shield structures 304, 306 described above with reference to FIG. 3. As with the previously described embodiment, the sensor stack 402 has first and second magnetic free layers 308, 310 with a non-magnetic spacer or barrier layer 312 there-between.

The sensor 400 includes an in-stack bias structure that includes magnetic tabs 318, 320 and very thin non-magnetic dusting layers 403, 404, located between the magnetic tabs 318, 320 and free layers 308, 310. The non-magnetic dusting layers 403, 404 can be formed of a material such as Ru or Ta, and each have a thickness that is chosen to provide a weak ferromagnetic exchange coupling between the free layer 310 and magnetic tab 320 and between the free layer 308 and magnetic tab 318. This weak ferromagnetic coupling causes the free layer 308 to have a magnetization 314 that is biased in the same direction as the magnetization 326 of the magnetic tab 318. Similarly, the weak exchange coupling causes the free layer 310 to have a magnetization 316 that is biased in the same direction as the magnetization 328 of the magnetic tab 320. That is to say, although the free layer magnetizations 314, 316 of the free layers are not parallel with the magnetizations 326, 328 of the magnetic tabs (as understood with reference to FIG. 2), they follow the direction of the magnetizations 326, 328. The non-magnetic layers 403, 404 can be referred to as dusting layers, because they are extremely thin. For example, if the dusting layers 403, 404 are constructed of Ru or Ta, they can have a thickness of only 6 to 15 Angstroms or about 10 Angstroms.

The magnetic tabs 318, 320 are exchange coupled with the magnetically pinned layers 332, 338 of the shields 304, 306 which pins the magnetizations 326, 328 of the magnetic tabs 318, 320 as described above. In theory, the magnetic tabs 320, 318 could be removed and the dusting layers 403, 404 could be directly located between the free layer 308, 310 and magnetic shield layers 332, 338. However, the magnetic tabs 318, 320 are useful for practical reasons related to manufacturability. As will be understood to those skilled in the art, the sensor layers, including layers 403, 308, 312, 310, 404 are formed by depositing the layers full film and then performing masking and milling operations to define the sides and stripe height of the sensor. During this masking and milling operation a certain amount of the top layer is removed. The top shield is then formed on top of the sensor layers. Because the dusting layer 404 is so thin, it would be impossible to control the amount of removal sufficiently to arrive at the exact required thickness. The top magnetic tab 320, however, acts as a capping layer during these masking and milling operations. Therefore, the thickness of the dusting layer 404 can be accurately controlled by deposition, and only the magnetic tab 320 will have its thickness affected by the masking and ion milling. The bottom magnetic tab 318 is useful in maintaining a magnetic balance between the upper portion of the sensor and lower portion of the sensor.

In the embodiment described above with reference to FIG. 3, the demagnetization field 346 provided the magnetic bias for the free layer magnetizations. In the embodiment of FIG. 4, such demagnetization field will still exist. However, because the exchange coupling causes each free layer 308, 310 to be biased in the same direction as the magnetization 326, 328 of the adjacent magnetic tab 318, 320, the demagnetization will be in the opposite direction from the magnetic biasing provided by this exchange coupling. Therefore, the demagnetization field will subtract from the net biasing. The biasing from the exchange coupling will have to be sufficiently strong to compensate for this subtractive demagnetization field.

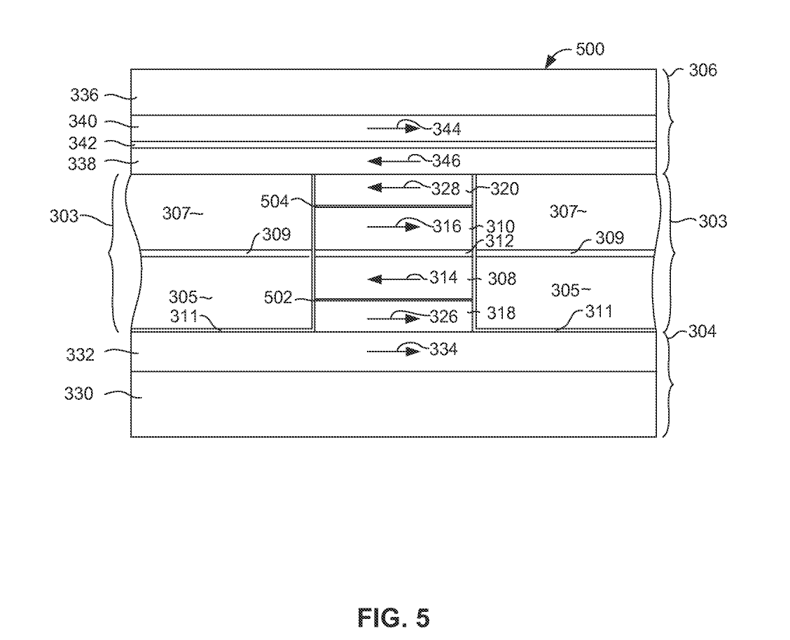

With reference now to FIG. 5, yet another embodiment is described. This embodiment includes a magnetic sensor 500 that includes an in stack magnetic bias structure that includes a first anti-parallel coupling layer 502 located between the magnetic free layer 308 and the magnetic tab 318 and a second anti-parallel coupling layer 504 located between the free layer 310 and the magnetic tab 320. Each of the anti-parallel coupling layers 502, 504 can be a material such as Ru, and has a thickness that is chosen to weakly, anti-parallel exchange couple the free layer 308 with the magnetic tab 318, and to weakly, anti-parallel exchange couple the free layer 310 with the magnetic tab 320. To this end, if the layers 502, 504 are constructed of Ru, they can have a thickness of 16 to 20A Angstroms or about 18 Angstroms.

In this embodiment, there will also be an inherent demagnetization field. However, in this case, the demagnetization field will be in the same direction as the magnetic biasing provided by the anti-parallel exchange coupling of the free layers 308, 310 with the magnetic tabs 318, 320. Therefore, in this case, the de-magnetization fields will be additive to the magnetic biasing. Also, again, the presence of the magnetic tabs 318, 320 would not be necessary from a theoretical standpoint for the magnetic biasing to work, but are advantageous from a manufacturing standpoint as described above with reference to FIG. 4 in order to carefully control the thickness of the layer 504, and provide magnetic balance between the upper and lower portions of the sensor.

While various embodiments have been described above, it should be understood that they have been presented by way of example only and not limitation. Other embodiments falling within the scope of the invention may also become apparent to those skilled in the art. Thus, the breadth and scope of the invention may also become apparent to those skilled in the art. Thus, the breadth and scope of the inventions should not be limited by any of the above-described exemplary embodiments, but should be defined only in accordance with the following claims and their equivalents.

1. A magnetic sensor, comprising:
first and second magnetic free layers anti-parallel coupled across a non-magnetic layer sandwiched there-between and having magnetizations that move in a scissoring fashion relative to one another; and
an in-stack magnetic bias structure comprising a magnetic tab layer that is separated from the one of the first and second magnetic free layers by a non-magnetic decoupling layer, and wherein a de-magnetization field from the magnetic tab provides a magnetic bias field for biasing one of the first or second magnetic free layers.

2. The magnetic sensor as in claim 1, wherein the magnetic tab layer is a first magnetic tab, and wherein the in stack bias layer further comprises:
a second magnetic tab separated from the second magnetic free layer by a second non-magnetic de-coupling layer.

3. The magnetic sensor as in claim 2, wherein each of the first and second magnetic tabs has a magnetization that is pinned in a direction parallel with a media facing surface of the magnetic sensor.

4. The magnetic sensor as in claim 3, wherein the magnetic tabs have magnetizations that are pinned in directions opposite to one another.

5. The magnetic sensor as in claim 3, wherein each of the magnetic tabs is exchange coupled with a magnetic shield that pins its magnetization.

6. The magnetic sensor as in claim 3, wherein each of the magnetic tabs has a width that is substantially equal to a width of the first and second magnetic free layers.

7. The magnetic sensor as in claim 6, further comprising anti-parallel coupled magnetic side shields at first and second sides of the first and second magnetic free layers.

8-20. (canceled)
